(19) United States
(12) Patent Application Publication
(10) Pub. No.: US 2008/0161954 A1
(43) Pub. Date: Jul. 3, 2008

(54) AUDIO DEVICE AND AUDIO SYSTEM RECEIVING RADIO SIGNAL TO REPRODUCE SOUND

(75) Inventors: Guokun Zuo, Osaka (JP); Yasuo Masaki, Osaka (JP); Akinori Okazaki, Osaka (JP); Masao Kokado, Osaka (JP); Sadanori Murakami, Osaka (JP); Masahiro Takeshita, Osaka (JP); Hirono Tsubota, Osaka (JP)

Correspondence Address: OSHA LIANG L.L.P., 1221 MCKINNEY STREET, SUITE 2800, HOUSTON, TX, 77010, US

(73) Assignee: FUNAI ELECTRIC CO., LTD., Osaka (JP)

(21) Appl. No.: 11/935,517

(22) Filed: Nov. 6, 2007

(30) Foreign Application Priority Data
Dec. 27, 2006 (JP) 2006-352306 (P)

(51) Int. Cl. G06F 17/00

(52) U.S. Cl. 700/94

(57) ABSTRACT

An audio device includes a connector to which a headphone or an earphone is connected, a receiver receiving a radio signal that is converted from an audio signal corresponding to video to be displayed at another device, a controller selecting music data or the received radio signal, and a second audio processor switching between conversion of music data to an audio signal or conversion of the received radio signal to an audio signal based on selection by the controller, and providing the converted audio signal to the headphone or the earphone via the connector.

### BACKGROUND OF THE INVENTION

1. Field of the Invention

The present invention relates to audio devices and systems, particularly an audio device and an audio system receiving radio signals to reproduce sound.

2. Description of the Background Art

Media players with a radio function are expected to achieve widespread use since they are convenient for data exchange with a personal computer and for obtaining content through the network. For example, Japanese Patent Laying-Open Nos. 2006-013906 (Patent Document 1), 2002-300238 (Patent Document 2), 2002-009903 (Patent Document 3), and 05-091169 (Patent Document 4) disclose an audio device with a radio function to process audio signals.

However, the aforementioned publications are silent about receiving radio signals including audio information corresponding to video to be displayed on a television set or the like and reproducing sound of high quality.

### SUMMARY OF THE INVENTION

An object of the present invention is to provide an audio device and audio system that can receive radio signals including audio information corresponding to video to be displayed at another device and reproducing sound of high quality.

An audio system according to an aspect of the present invention includes a video display device, and an audio device. The video display device includes a display unit displaying video, a first audio processor obtaining an audio signal corresponding to the video, and a transmitter converting the audio signal to a radio signal for transmission. The audio device includes a connector to which a headphone or an earphone is connected, a receiver receiving a radio signal, a controller selecting one of music data and the received radio signal, and a second audio processor switching between conversion of the music data to an audio signal or conversion of the received radio signal to an audio signal based on selection by the controller, and providing the converted audio signal to the headphone or the earphone via the connector. The second audio processor converts the received radio signal to an audio signal by a streaming reproduction scheme. The audio device further includes a storage unit storing the music data. The video display device further includes a receiver receiving a television broadcast signal, and a video processor extracting a video signal from the received television broadcast signal. The display unit displays video based on the video signal. The first audio processor obtains an audio signal corresponding to the video based on the received television broadcast signal.

An audio system according to another aspect of the present invention includes a video display device and an audio device. The video display device includes a display unit displaying video, a first audio processor obtaining an audio signal corresponding to the video, and a transmitter converting the audio signal to a radio signal for transmission. The audio device includes a connector to which a headphone or an earphone is connected, a receiver receiving a radio signal, a controller selecting one of music data and the received radio signal, and a second audio processor switching between conversion of the music data to an audio signal or conversion of the received radio signal to an audio signal based on the selection by the controller and providing the converted audio signal to the headphone or the earphone via the connector.

Preferably, the second audio processor converts the received radio signal to an audio signal by a streaming reproduction scheme.

Preferably, the audio device further includes a storage unit storing the music data.

Preferably, the video display device further includes a receiver receiving a television broadcast signal, and a video processor extracting a video signal from the received television broadcast signal. The display unit displays the video based on the video signal. The first audio processor extracts an audio signal corresponding to the video from the received television broadcast signal.

An audio device according to a further aspect of the present invention includes a connector to which a headphone or an earphone is connected, a receiver receiving a radio signal that is converted from an audio signal corresponding to video to be displayed at another device, a controller selecting one of music data and the received radio signal, and an audio processor switching between conversion of the music data to an audio signal or conversion of the received radio signal to an audio signal based on selection by the controller, and providing the converted audio signal to the headphone or the earphone via the connector. The audio processor converts the received radio signal to an audio signal by a streaming reproduction scheme. The audio device further includes a storage unit storing the music data. The receiver receives a radio signal that is converted from an audio signal corresponding to video to be displayed at a television device.

An audio device according to still another aspect of the present invention includes a connector to which a headphone or an earphone is connected, a receiver receiving a radio signal that is converted from an audio signal corresponding to video to be displayed at another device, a controller selecting one of music data and the received radio signal, and an audio processor switching between conversion of the music data to an audio signal or conversion of the received radio signal to an audio signal based on selection by the controller, and providing the converted audio signal to the headphone or the earphone via the connector.

Preferably, the audio processor converts the received radio signal to an audio signal by a streaming reproduction scheme.

Preferably, the audio device further includes a storage unit storing the music data.

Preferably, the receiver receives a radio signal that is converted from an audio signal corresponding to video to be displayed at a television device.

By virtue of the present invention, a radio signal including audio information corresponding to video to be displayed at another device can be received to reproduce sound of high quality.

The foregoing and other objects, features, aspects and advantages of the present invention will become more apparent from the following detailed description of the present invention when taken in conjunction with the accompanying drawings.

### BRIEF DESCRIPTION OF THE DRAWINGS

FIG. 1 represents a configuration of an audio system according to an embodiment of the present invention.

FIG. 2 is a functional block diagram of a configuration of a television device according to an embodiment of the present invention.

FIG. 3 is a functional block diagram of a configuration of an audio device according to an embodiment of the present invention.

### DESCRIPTION OF THE PREFERRED EMBODIMENTS

Embodiments of the present invention will be described hereinafter with reference to the drawings. In the drawings, the same or corresponding components have the same reference characters allotted, and description thereof will not be repeated.

Configuration and Basic Operation

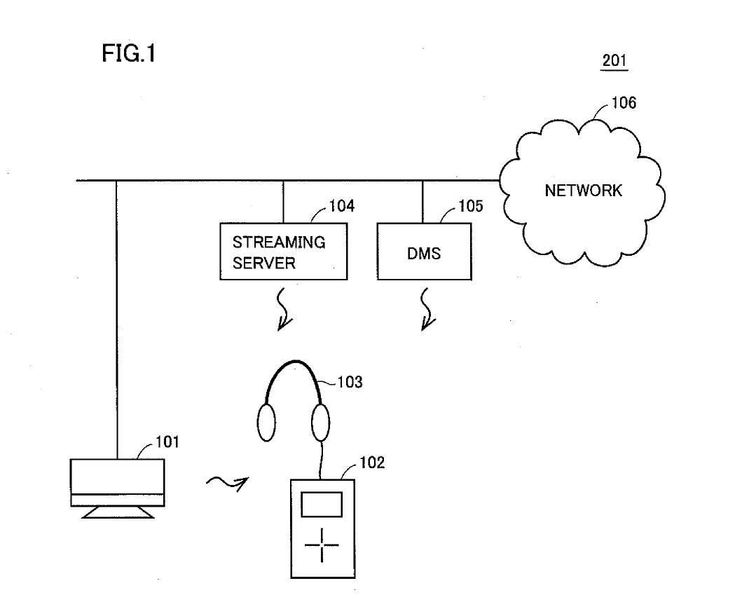

FIG. 1 represents a configuration of an audio system according to an embodiment of the present invention.

Referring to FIG. 1, an audio system 201 includes a television device (video display device) 101, an audio device 102, a streaming server 104, and a DMS (Digital Media Server) 105. A headphone 103 is attached to audio device 102.

Streaming server 104 converts digital content such as sound and video, downloaded via a network 106, i.e. received through network 106, to data corresponding to a streaming scheme, and converts the converted data to radio signals for transmission to audio device 102. Streaming server 104 may be configured to convert data such as sound and video corresponding to the streaming scheme, received through network 106, to radio signals for transmission to audio device 102.

DMS 105 stores digital content such as sound and video. Furthermore, DMS 105 converts the stored digital content to radio signals for transmission to audio device 102.

Television device 101 receives a television broadcast signal to display video based on the received television broadcast signal. Television device 1001 also extracts an audio signal corresponding to the video to be displayed from the received television broadcast signal, and converts the extracted audio signal to a radio signal for transmission to audio device 102. Television device 101 may be configured to incorporate a transmitter transmitting a radio signal, or have a wireless device connected thereto via an audio output terminal to which a headphone or the like is connected.

Audio device 102 is, for example, a media player, converting radio signals received from streaming server 104 to audio signals, video signals, and the like by the streaming reproduction scheme. In addition, audio device 102 converts radio signals received from DMS 105 to audio signals, video signals, and the like. Audio device 102 displays video based on the converted video signal, and provides the converted audio signal to headphone 103. Audio device 102 converts the radio signal received from television device 101 to an audio signal, and provides the converted audio signal to headphone 103.

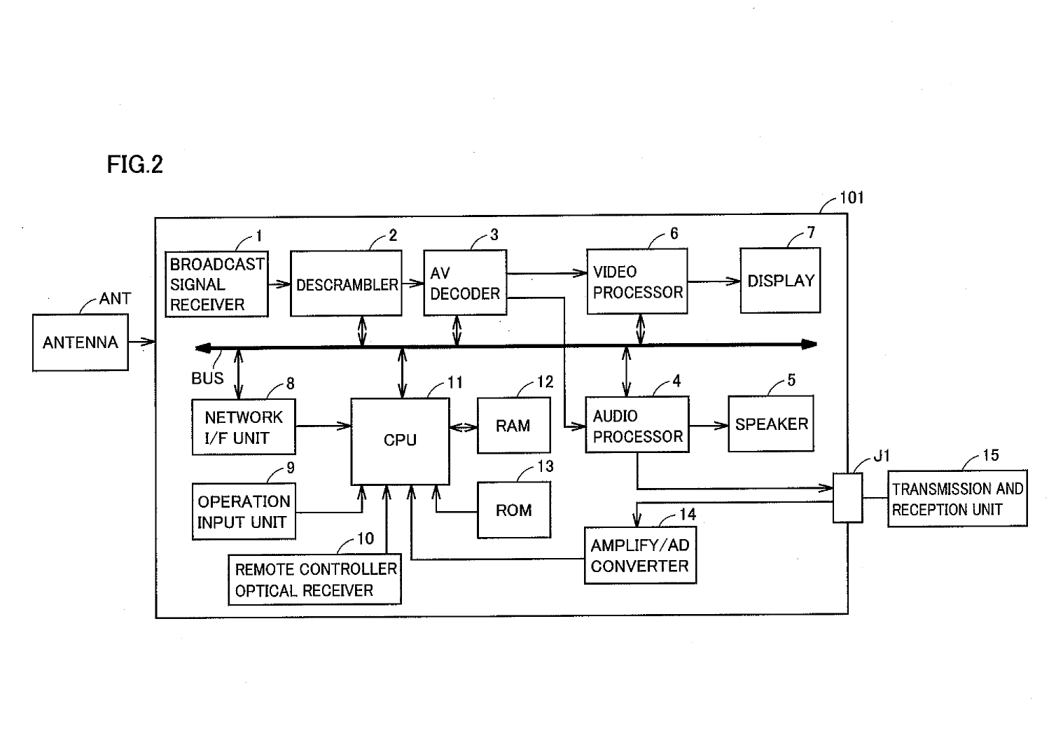

FIG. 2 is a functional block diagram of a configuration of a television device according to an embodiment of the present invention.

Referring to FIG. 2, television device 101 includes a broadcast signal receiver 1, a descrambler 2, an AV (Audio Visual) decoder 3, an audio processor (first audio processor) 4, a speaker 5, a video processor 6, a display (display unit) 7, a network I/F (interface) unit 8, an operation input unit 9, a remote controller optical receiver 10, a CPU (Central Processing Unit) 11, a RAM (Random Access Memory) 12, a ROM (Read Only Memory) 13, an amplify/AD (Analog Digital) converter 14, and a jack (connector) J1. Television device 101 may be configured to include a transmission and reception unit 15.

Broadcast signal receiver 1 receives a television broadcast signal that is subjected to scrambling via an antenna ANT and provides the scrambled television broadcast signal to descrambler 2.

Descrambler 2 descrambles the television broadcast signal from television signal receiver 1 to restore the signal to the state prior to scrambling, and provides the restored signal to AV decoder 3.

AV decoder 3 decodes the restored signal from descrambler 2 and provides the decoded signal to audio processor 4 and video processor 6.

Video processor 6 extracts a video signal from the decoded signal output from AV decoder 3, and provides the extracted video signal to display 7. Display 7 provides video based on the video signal received from video processor 6.

Audio processor 4 extracts an audio signal from the decoded signal output from AV decoder 3, i.e. obtains an audio signal corresponding to the video to be displayed by display 7. Audio processor 4 provides the extracted audio signal to speaker 5. Speaker 5 provides sound based on the audio signal received from audio processor 4. Audio processor 4 provides the extracted audio signal to transmission and reception unit 15 via jack J1.

Transmission and reception unit 15 converts the audio signal received from audio processor 4 to a radio signal for transmission to audio device 102. Furthermore, transmission and reception unit 15 receives a radio signal from audio device 102 and provides the radio signal to amplify/AD converter 14. Transmission and reception unit 15 accommodates IEEE802.11a/11b/11g, i.e. WiFi (Wireless Fidelity), that is the standard of a wireless LAN.

Amplify/AD converter 14 amplifies the signal received from transmission and reception unit 15, and converts the amplified signal to digital data for output to CPU 11.

Operation input unit 9 recognizes an operation made by the user such as button depression at television device 101, and provides data representing the operation information to CPU 11.

Remote controller optical receiver 10 recognizes an operation made by the user such as button depression on the remote controller, and provides data representing the operation information to CPU 11.

Network interface unit 8 provides data received through a network to CPU 11.

CPU 11 controls respective blocks of television device 101 based on the data stored in RAM 12 and ROM 13, as well as data received from amplify/AD converter 14, network interface unit 8, operation input unit 9, and remote controller optical receiver 10.

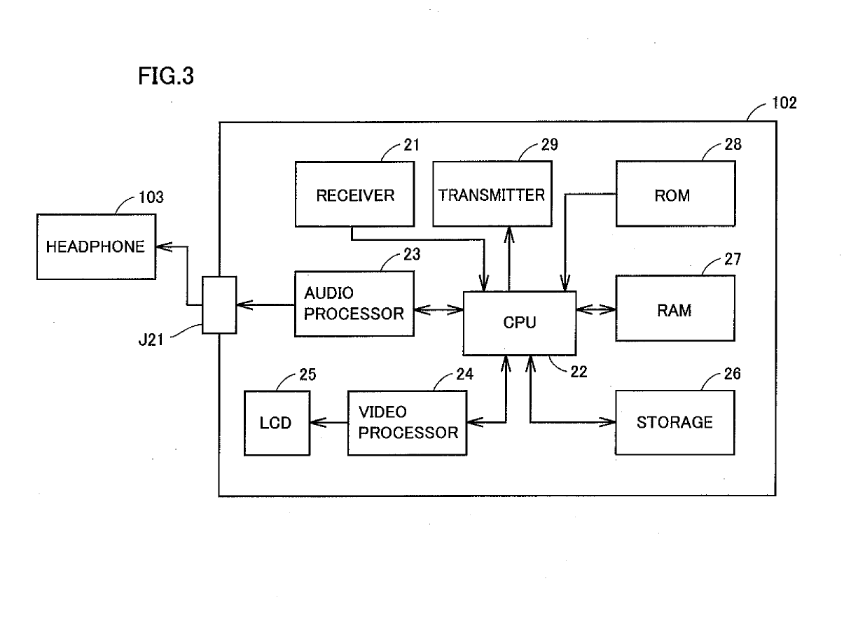

FIG. 3 is a functional block diagram of a configuration of an audio device according to an embodiment of the present invention.

Referring to FIG. 3, audio device 102 includes a receiver 21, a CPU (control unit) 22, an audio processor (second audio processor) 23, a video processor 24, an LCD (Liquid Crystal Display) 25, a storage unit 26, a RAM 27, a ROM 28, and a jack (connector) J21. Receiver 21 and transmitter 29 accommodate IEEE802.11a/11b/11g, i.e. WiFi (Wireless Fidelity), qualified as the standard of a wireless LAN.

Headphone 103 is connected to jack J21. Alternatively, an earphone may be connected to jack J21.

Receiver 21 receives a radio signal from television device 101 and streaming server 104 to provide the signal to CPU 22 as a reception signal.

CPU 22 provides the reception signal from receiver 21 to audio processor 23 and video processor 24.

Video processor 24 generates a video signal based on the reception signal from CPU 22, and provides the generated video signal to LCD 25. LCD 25 provides a display of video based on the video signal from video processor 24.

Storage unit 26 stores music data included in the radio signal received from DMS 105 or music data directly written into storage unit 26. CPU 22 reads out music data from storage unit 26.

CPU 22 selects the music data obtained from storage unit 26 or the reception signal from receiver 21, based on an operation by the user, for output to audio processor 23.

When CPU 22 selects the reception signal, audio processor 23 converts the reception signal from CPU 22 to an audio signal by, for example, a streaming reproduction scheme. Specifically, audio processor 23 temporarily stores a newly received audio signal from CPU 22 in a buffer not shown and, at the same time, converts an obtained reception signal previously received from CPU 22 and stored in the buffer to an audio signal. Since the time required for conversion to an audio signal is shorter than that for conversion to a video signal, the delay in reproducing sound at audio device 102 with respect to the display of video at television device 101 can be suppressed to a level almost indiscernible to the user.

Audio processor 23 corresponds to, for example, a digital media player (DMP) function, streaming client function, and the like.

Audio processor 23 converts the music data from CPU 22 to an audio signal when CPU 22 selects music data.

Then, audio processor 23 provides the converted audio signal to headphone 103 via jack J21. Headphone 103 emits sound based on the audio signal from audio processor 23.

Transmitter 29 converts the data from CPU 22 to a radio signal, and provides the radio signal to television device 101.

Patent Documents 1-4 are silent about a configuration in which a radio signal including audio information corresponding to video to be displayed at another device such as a television broadcast signal is received to reproduce sound of high quality. The audio device according to an embodiment of the present invention has CPU 22 select a radio signal that is converted from an audio signal corresponding to video to be displayed at television device 101, or select music data. Audio processor 23 switches between conversion of music data to an audio signal or the received radio signal to an audio signal based on the selection by CPU 22, and provides the converted audio signal to headphone 103 via connector J21. By such a configuration, a radio signal including audio signal corresponding to video to be displayed at another device can be received for reproduction of sound. By the configuration of reproducing the sound of television device 101 through audio device 102, high sound quality can be realized taking advantage of the high audio reproduction function of audio device 102.

By reproducing the sound of television device 101 through audio device 102 in real time, a radio signal including audio information such as a television broadcast signal requiring real-time processing can be received to allow real-time reproduction. The headphone connected to audio device 102 can be used effectively. Furthermore, by adding the function of reproducing sound of television device 101 to audio device 102, the additional value of audio device 102 can be improved.

In the audio device according to an embodiment of the present invention, CPU 22 selects music data or a reception signal, based on an operation by the user, for example, for output to audio processor 23. Audio processor 23 converts the music data or reception signal from CPU 22 to an audio signal. The present invention is not limited to the above-described configuration. For example, audio processor 23 can receive a reception signal from receiver 21 and music data from CPU 22. CPU 22 selects music data or a reception signal based on the user's operation and outputs a control signal representing the selected result to audio processor 23. Audio processor 23 may be configured to switch between conversion of music data to an audio signal or conversion of a reception signal to an audio signal by a streaming reproduction scheme, based on a control signal from CPU 22.

The audio system according to an embodiment of the present invention was described including television device 101. The present invention is not limited thereto. A configuration employing a video display device other than television device 101, providing a video display and converting an audio signal corresponding to the video to a radio signal for transmission may be implemented.

Although the present invention has been described and illustrated in detail, it is clearly understood that the same is by way of illustration and example only and is not to be taken by way of limitation, the scope of the present invention being interpreted by the terms of the appended claims.

What is clamed is:

1. An audio system comprising:
a video display device, and
an audio device,
wherein said video display device includes
a display unit displaying video,
a first audio processor obtaining an audio signal corresponding to said video, and
a transmitter converting said audio signal to a radio signal for transmission,
wherein said audio device includes
a connector to which a headphone or an earphone is connected,
a receiver receiving said radio signal,
a controller selecting one of music data and said received radio signal,
a second audio processor switching between conversion of said music data to an audio signal or conversion of said received radio signal to an audio signal based on selection by said controller, and providing said converted audio signal to said headphone or said earphone via said connector, said second audio processor converting said received radio signal to said audio signal by a streaming reproduction scheme, and
a storage unit storing said music data,
wherein said video display device further includes
a receiver receiving a television broadcast signal, and
a video processor extracting a video signal from said received television broadcast signal,
said display unit displays video based on said video signal,
said first audio processor obtains an audio signal corresponding to said video based on said received television broadcast signal.

2. An audio system comprising:
a video display device, and an audio device,
wherein said video display device includes
a display unit displaying video,
a first audio processor obtaining an audio signal corresponding to said video, and
a transmitter converting said audio signal to a radio signal for transmission,
wherein said audio device includes
a connector to which a headphone or an earphone is connected,
a receiver receiving said radio signal,
a controller selecting one of music data and said received radio signal, and
a second audio processor switching between conversion of said music data to an audio signal or conversion of said received radio signal to an audio signal based on selection by said controller, and providing said converted audio signal to said headphone or said earphone via said connector.

3. The audio system according to claim 2, wherein said second audio processor converts said received radio signal to said audio signal by a streaming reproduction scheme.

4. The audio system according to claim 2, wherein said audio device further includes a storage unit storing said music data.

5. The audio system according to claim 2, wherein said video display device further includes
a receiver receiving a television broadcast signal, and
a video processor extracting a video signal from said received television broadcast signal,
said display unit displaying video based on said video signal,
said first audio processor extracting an audio signal corresponding to said video from said received television broadcast signal.

6. An audio device comprising.
a connector to which a headphone or an earphone is connected,
a receiver receiving a radio signal that is converted from an audio signal corresponding to video to be displayed at another device,
a controller selecting one of music data and said received radio signal, and
an audio processor switching between conversion of said music data to an audio signal or conversion of said received radio signal to an audio signal based on selection by said controller, and providing said converted audio signal to said headphone or said earphone via said connector, said audio processor converting said received radio signal to said audio signal by a streaming reproduction scheme, and
a storage unit storing said music data,
said receiver receiving a radio signal that is converted from an audio signal corresponding to video to be displayed at a television device.

7. An audio device comprising:
a connector to which a headphone or an earphone is connected,
a receiver receiving a radio signal that is converted from an audio signal corresponding to video to be displayed at another device,
a controller selecting one of music data and said received radio signal, and
an audio processor switching between conversion of said music data to an audio signal or conversion of said received radio signal to an audio signal based on selection by said controller, and providing said converted audio signal to said headphone or said earphone via said connector.

8. The audio device according to claim 7, wherein said audio processor converts said received radio signal to said audio signal by a streaming reproduction scheme.

9. The audio device according to claim 7, wherein said audio device further includes a storage unit storing said music data.

10. The audio device according to claim 7, wherein said receiver receives a radio signal that is converted from an audio signal corresponding to video to be displayed at a television device.
